(19) United States
(12) Patent Application Publication
(10) Pub. No.: US 2026/0338148 A1
(43) Pub. Date: Oct. 29, 2026

(54) FUEL INJECTION DEVICE

(71) Applicant: TOYOTA JIDOSHA KABUSHIKI KAISHA, Toyota-shi (JP)

(72) Inventor: Junpei SHOUJI, Toyota-shi (JP)

(73) Assignee: TOYOTA JIDOSHA KABUSHIKI KAISHA, Toyota-shi (JP)

(21) Appl. No.: 19/533,620

(22) Filed: Feb. 9, 2026

(30) Foreign Application Priority Data
Apr. 25, 2025 (JP) 2025-073209

(51) Int. Cl. F02M 61/10

(52) U.S. Cl. CPC F02M 61/10; F02M 2200/8084

(57) ABSTRACT

The injector injects fuel by moving a needle accommodated in a fuel chamber in the housing along a central axis of the needle and separating a spherical valve element provided at a tip of the needle from an annular valve seat. In the injector, a nozzle plate having a plurality of injection holes is welded and fixed to an outer side of a valve seat portion, which is a tip portion of the housing where the valve seat is provided, with a locus surrounding a portion where the plurality of injection holes are located. In the injector, the weld bead is located outside the inner diameter of the valve seat and is point-asymmetric with respect to the center point, which is a point through which the central axis of the surface of the nozzle plate passes, from the viewpoint of the front view of the nozzle plate at the tip.

### CROSS-REFERENCE TO RELATED APPLICATION

This application claims priority to Japanese Patent Application No. 2025-073209 filed on Apr. 25, 2025. The disclosure of the above-identified application, including the specification, drawings, and claims, is incorporated by reference herein in its entirety.

### BACKGROUND

### 1. Technical Field

The present disclosure relates to a fuel injection device.

### 2. Description of Related Art

Japanese Unexamined Patent Application Publication No. 2013-024170 (JP 2013-024170 A) discloses a structure of a valve device for use in a fuel injection valve or the like. The valve device includes an elastically deformable portion at the distal end portion of a valve element. The elastically deformable portion is formed by providing a notch or a protrusion at the distal end portion of the valve element. This valve device improves the oil tightness by elastically deforming the distal end portion of the valve element when the distal end portion of the valve element is seated on a valve seat of the valve device.

### SUMMARY

In order to provide the elastically deformable portion at the distal end portion of the valve element, it is necessary to perform a process of providing the valve element with a notch or a protrusion.

In order to address the above issue, there is provided a fuel injection device that injects fuel by moving a needle accommodated in a fuel chamber in a housing along a central axis of the needle to move a valve element in a spherical shape provided at a tip of the needle away from a valve seat in an annular shape.

In the fuel injection device, a plate having a plurality of injection holes is welded and fixed to an outer side of a distal end portion of the housing where the valve seat is provided with a locus surrounding a portion where the injection holes are located.

In the fuel injection device, when seen from a viewpoint at which the plate at the distal end portion is seen from front, a weld bead is located on an outer side of an inner diameter of the valve seat and is asymmetric with respect to a point on a surface of the plate through which the central axis passes.

According to the above fuel injection device, it is possible to suppress the occurrence of fuel leakage, while it is possible to manufacture the fuel injection device only by slightly changing the welding path, without requiring the costly process of providing a valve element with a notch or a protrusion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a configuration of an injector according to an embodiment of a fuel injection device;

FIG. 2 is an enlarged view of a portion of FIG. 1 surrounded by a circle of a dashed-dotted line;

FIG. 3 is a front view of the nozzle plate of FIG. 2 viewed from a distal end side;

FIG. 4 is a front view of the nozzle plate of the comparative example as viewed from the tip side;

FIG. 5 is a front view of a modified nozzle-plate from the distal end; and

FIG. 6 is a front view of another modification of the nozzle plate as viewed from the distal end side.

### DETAILED DESCRIPTION OF EMBODIMENTS

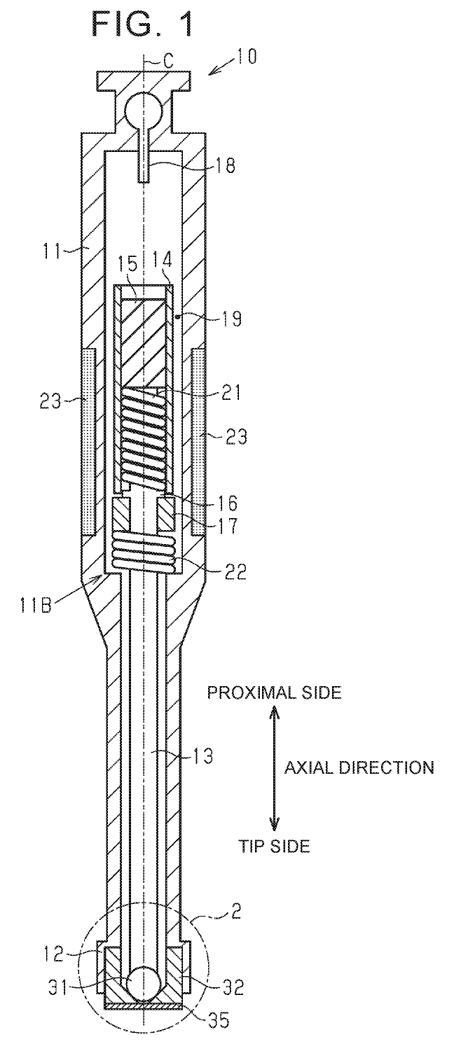

Hereinafter, an injector 10, which is an embodiment of a fuel injection device, will be described with reference to FIGS. 1-4. The injector 10 is provided in, for example, an engine mounted in a vehicle. The injector 10 is a fuel injection device that injects fuel into a cylinder of an engine.

When the shut-off valve provided in the injector 10 is in the open state, fuel is injected from the tip of the injector 10 into the cylinder. On the other hand, when the shut-off valve provided in the injector 10 is in the closed state, the fuel is not injected from the injector 10. Examples of fuels are gasoline and gas oil.

### Configuration of the injector 10

As illustrated in FIG. 1, the injector 10 includes a housing 11, a valve seat portion 32, and a nozzle plate 35.

The housing 11 has a substantially cylindrical shape having an outer diameter and an inner diameter that vary along the longitudinal direction of the housing 11. The housing 11 is provided with a valve accommodating portion 12. A substantially cylindrical valve seat portion 32 is accommodated in the valve accommodating portion 12. A nozzle plate 35 is attached to the valve seat portion 32. The valve seat portion 32 is part of the housing 11. The valve seat portion 32 is a distal end of the housing 11. On the other hand, an end portion of the housing 11 opposite to the valve seat portion 32 is a proximal end of the housing 11. In FIG. 1, the upper end portion in FIG. 1 is a proximal end, and the lower end portion in FIG. 1 is a distal end.

The housing 11 is provided with a boundary portion 11B whose inner diameter varies. In the housing 11, an inner diameter of the housing 11 closer to the proximal end than the boundary portion 11B is larger than an inner diameter of the housing 11 closer to the distal end than the boundary portion 11B.

A space inside the housing 11 is a fuel chamber 19. The fuel chamber 19 is filled with high-pressure fuel. Fuel is supplied to the fuel chamber 19 through a fuel nozzle 18 provided at the proximal end of the housing 11. The fuel nozzle 18 is connected to, for example, a fuel tank mounted on the vehicle via a fuel supply path.

The fuel chamber 19 houses an elongated substantially cylindrical needle 13 extending along the axial direction of the housing 11. A spherical valve element 31 is provided at the distal end of the needle 13. The shape of the valve element 31 shown in FIG. 1 is a true sphere.

An axis C indicated by a one-dot chain line in FIG. 1 is a central axis of the needle 13. The axis C also coincides with the central axis of the housing 11. Hereinafter, a direction extending along the axis C is referred to as an axial direction.

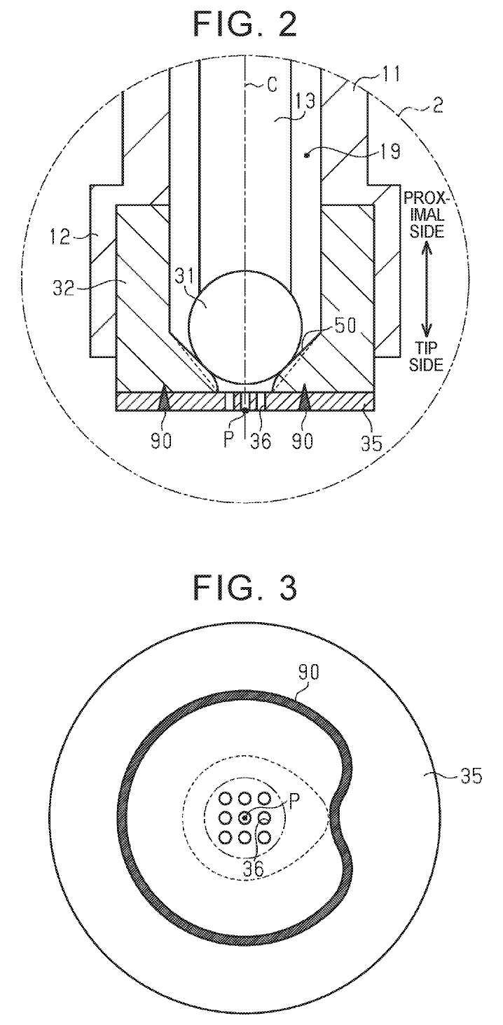

FIG. 2 is an enlarged view of a portion surrounded by a circle 2 of a dashed-dotted line in FIG. 1. As shown in FIG. 2, a nozzle plate 35 having an injection hole 36 is welded to the valve seat portion 32. That is, the nozzle plate 35 is welded and fixed to the outside of the distal end portion of the housing 11. Thus, in the injector 10, the nozzle plate 35 is positioned at the tip of the injector 10.

As will be described later, the nozzle plate 35 is provided with nine injection holes 36. The welding locus when the nozzle plate 35 is welded to the valve seat portion 32 is referred to as a weld bead 90. As shown in FIGS. 1 and 2, the nozzle plate 35 side in the axial direction is referred to as a distal end side, and the proximal end side of the housing 11 in the axial direction is referred to as a proximal end side.

The valve element 31 and the valve seat portion 32 constitute a shut-off valve. FIG. 2 shows the positional relationship between the valve element 31 and the valve seat portion 32 when the shut-off valve is in the closed state. As shown in FIG. 2, when the shut-off valve is in the closed state, the valve element 31 is in contact with an annular valve seat 50 provided on the inner surface of the valve seat portion 32. The valve seat 50 is inclined such that the diameter of the distal portion of the valve seat portion 32 is smaller.

The inner diameter of the valve seat 50 is the smallest diameter portion of the valve seat 50. Thus, the inner diameter of the valve seat 50 is the diameter of the most distal portion of the valve seat 50. The inner diameter of the valve seat 50 is the diameter of the valve seat 50 at the portion where the valve seat 50 is in contact with the nozzle plate 35.

In FIGS. 1 and 2, the center of the valve element 31 is located on the axis C. The central axis of the annular ring of the valve seat 50 coincides with the axis C. The intersection point between the axis C and the front end side surface of the nozzle plate 35 is the center point P. The center point P is a point through which the axis C passes on the surface of the nozzle plate 35.

As shown in FIG. 1, a needle 13, a fixed core 14, a movable core 17, a first spring 21, and a second spring 22 are accommodated in the housing 11. The fixed core 14, the movable core 17, the first spring 21, and the second spring 22 are accommodated in a part of the housing 11 closer to the proximal end than the boundary portion 11B.

The proximal portion of the needle 13 is inserted into a substantially cylindrical fixed core 14. The fixed core 14 is fixed to the housing 11 via a flange portion (not shown). The fixed core 14 is a magnetic component.

A cylindrical adjuster portion 15 is provided on the inner side of the fixed core 14 and on the proximal end side of the fixed core 14. The first spring 21 is accommodated inside the fixed core 14 and at a portion on the distal end side of the fixed core 14 with respect to the adjuster portion 15. At this time, the first spring 21 is accommodated in the fixed core 14 in a state of being compressed more than the free length. The proximal end portion of the first spring 21 is in contact with the distal end portion of the adjuster portion 15. The proximal portion of the needle 13 is inserted into the adjuster portion 15 and the first spring 21. The needle 13 is provided with a flange 16 which is a disk-shaped projection orthogonal to the axis C. The flange 16 of the needle 13 is in contact with the distal end of the first spring 21.

The needle 13 is inserted through the inside of the movable core 17 having a substantially annular shape. The movable core 17 is located on the distal end side of the flange 16 of the needle 13. The inner diameter of the annular ring of the movable core 17 is smaller than the outer diameter of the flange 16 of the needle 13. The movable core 17 is a magnetic component.

The needle 13 passes through the inside of the second spring 22. The second spring 22 is located on the distal end side of the movable core 17. In the second spring 22, the proximal end portion of the second spring 22 is in contact with the distal end portion of the movable core 17, and the distal end portion of the second spring 22 is in contact with the inner surface of the housing 11 just 11B the boundary portion. The second spring 22 is sandwiched between the movable core 17 and the inner surface of the housing 11 in a state of being compressed more than the free length. The second spring 22 pushes up the movable core 17 to bring the movable core 17 into contact with the flange 16.

A coil 23 is embedded in the housing 11 at a position where the fixed core 14 and the movable core 17 are arranged in the axial direction. The coil 23 is an electromagnet that generates a magnetic field by energization.

### Operation of the injector 10

The injector 10 controls opening and closing of the shut-off valve by moving the needle 13 along the axial direction.

First, when the shut-off valve is in the closed state, as shown in FIGS. 1 and 2, the valve element 31 is in contact with the valve seat 50. This state is expressed as a state in which the valve element 31 is seated on the valve seat 50. The valve element 31 is pressed against the valve seat 50 by the needle 13 being pushed toward the distal end side by the restoring force of the first spring 21.

When the shut-off valve in the valve-closed state is opened, the injector 10 energizes the coil 23 to generate a magnetic field. The generated magnetic field magnetizes the fixed core 14 and the movable core 17. Then, an attractive force that attracts the movable core 17 to the fixed core 14 by the magnetic force acts. When the movable core 17 moves to the proximal end side due to the attractive force, the needle 13 moves to the proximal end side via the flange 16 against the bias caused by the restoring force of the first spring 21. In this way, the valve element 31 is separated from the valve seat 50, and the shut-off valve is opened. When the shut-off valve is opened, the high-pressure fuel filled in the fuel chamber 19 is injected through the injection hole 36 provided in the nozzle plate 35.

When the energization of the coil 23 is completed, since there is no attractive force due to the magnetic force, the needle 13 is pushed toward the distal end side by the restoring force of the first spring 21. Then, the valve element 31 is seated on the valve seat 50, and the shut-off valve is closed again.

### Shape of the weld bead 90

FIG. 3 shows the shape of the weld bead 90 from a front view of the surface of the nozzle plate 35. The broken line in FIG. 3 schematically shows the shape of the valve seat 50 in a cross section in which the valve element 31 comes into contact with the valve seat 50 when the valve element 31 is seated on the valve seat 50. Note that the shape indicated by the broken line shows an exaggerated amount of deformation due to the influence of a spring back described later so that the characteristics of the shape can be visually observed. The dashed line in FIG. 3 indicates the inner diameter of the valve seat 50.

As shown in FIG. 3, the weld bead 90 has a shape in which the right end portion of the positive circle is recessed toward the center point P. That is, the weld bead 90

is a locus having a shape in which a part of the regular circle is recessed toward the center point P. The weld bead 90 is a locus surrounding the entire portion of the nozzle plate 35 where the nine injection holes 36 are provided. The weld bead 90 surrounds the outer side of the inner diameter of the valve seat 50, which is indicated by a dashed line in FIG. 3.

The shape of the weld bead 90 is not point-symmetric with respect to the center point P. That is, the weld bead 90 is point asymmetric.

As shown by a broken line in FIG. 3, the shape of the valve seat 50 in a cross section in which the valve element 31 contacts the valve seat 50 has a shape in which the right end portion of the positive circle bulges radially outward. That is, the shape of the valve seat 50 in the cross section in which the valve element 31 is in contact with the valve seat 50 is a shape in which the direction recessed with respect to the regular circle in the weld bead 90 bulges radially outward.

### Operation of this embodiment

The valve seat 50 on which the spherical valve element 31 is seated is finished by grinding to increase the roundness after the nozzle plate 35 is welded to the distal end portion. During grinding, the valve seat 50 is slightly elastically deformed because the tool is processed in a pressed state. When the machining is completed, the restraint by the tool is released, so that the valve seat 50 is slightly deformed by the spring back caused by the restoring force. For example, as shown in FIG. 2, the valve seat 50 during grinding is elastically deformed as shown by a broken line in FIG. 2. Then, when the restraint by the tool is released after the processing, the valve seat 50 is deformed by the spring back, and has a shape as shown by a solid line in FIG. 2, for example. As in FIG. 3, the deformation amount in FIG. 2 is also exaggerated and larger than the actual deformation amount. For example, when the inner diameter of the valve seat 50 during grinding is several millimeters, the deformation amount is a size of several micrometers or less.

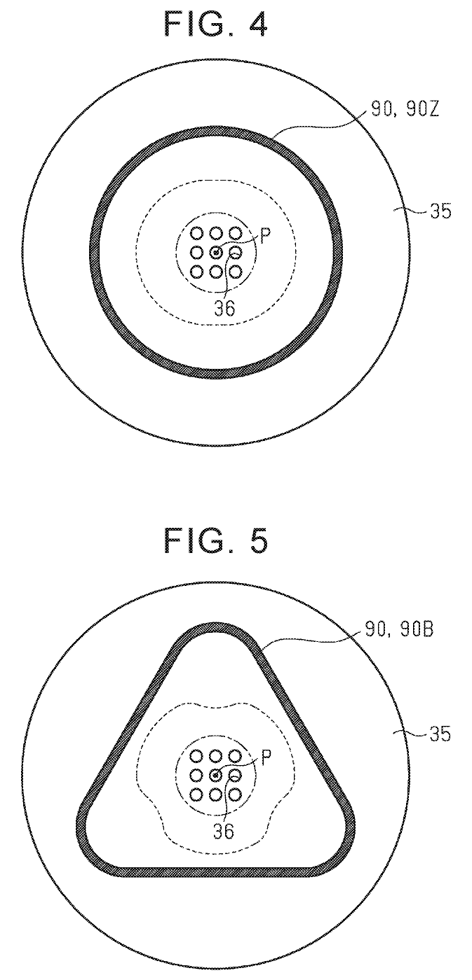

The deformation amount is not necessarily uniform over the entire circumference. For example, as shown in FIG. 4, when the shape of the valve seat 50 becomes oval due to slight deformation caused by spring back, the shape of the valve seat 50 in the cross section where the valve element 31 comes into contact with the valve seat 50 becomes a shape indicated by a broken line in FIG. 4. In this case, when the valve element 31 is seated on either one of the left and right sides of the valve seat 50 in FIG. 4, a large gap is generated between the valve element 31 and the valve seat 50. Assuming that the amount of fuel leakage can be approximated by the plane Poiseuille flow, the amount of fuel leakage is proportional to the cube of the size of the gap. That is, when the valve seat 50 is deformed into a shape in which a gap with the valve element 31 is likely to be large, fuel leakage is likely to increase.

When the valve seat 50 has a point-symmetric shape, the shape of the valve seat 50 in a cross section where the valve element 31 contacts the valve seat 50 also has a point-symmetric shape. As a result, the valve element 31 is easily seated on one side of the valve seat 50, so that a large gap is likely to be generated.

The rigidity of the valve seat 50 increases in a portion close to the weld bead 90. Since the weld bead 90 of the injector 10 is point-symmetric, an asymmetric intensity distribution is generated in the valve seat 50. Therefore, the injector 10 tends to have a shape in which the valve seat 50 is asymmetrical due to slight deformation caused by spring back after grinding. In the case of the weld bead 90 of FIG. 3, the right portion of FIG. 3 has a close distance between the valve seat 50 and the weld bead 90. Therefore, since the rigidity of the valve seat 50 is high in the right portion of the valve seat 50, the amount of deformation due to spring back is reduced. As a result, the shape of the valve seat 50 becomes asymmetric due to the shape in which the right side of the valve seat 50 bulges radially outward. Specifically, the shape of the valve seat 50 in the cross section where the valve element 31 is in contact with the valve seat 50 has a shape as indicated by a broken line in FIG. 3. This shape, shown in dashed lines in FIG. 3, is point asymmetric.

As described above, the injector 10 realizes a shape in which fuel leakage is less likely to occur by making the weld bead 90 asymmetric.

On the other hand, as shown in FIG. 4, when the weld bead 90 has a regular circular weld bead 90Z, as shown by a broken line in FIG. 4, the shape of the valve seat 50 in a cross section where the valve element 31 contacts the valve seat 50 may be a point-symmetrical shape.

### Effect of this embodiment

(1) According to the injector 10, it is possible to manufacture only by slightly changing the welding path without requiring processing of providing a notch or a protrusion in the expensive valve element 31, and it is possible to suppress the occurrence of fuel leakage.
(2) In the injector 10, the weld bead 90 has a trajectory in which a part of a regular circle is recessed toward the center.

According to the injector 10, the effect (1) can be realized by using a simple shape close to a circle.

### Example of change

The present embodiment can be modified and implemented as follows. The present embodiment and modification examples described below may be carried out in combination of each other within a technically consistent range.

In the injector 10, the weld bead 90 may have a shape in which a part of a positive circle protrudes radially outward. For example, the weld bead 90 of the injector 10 may have a portion protruding radially outward from the circumference of the positive circle on one of the positive circles. In this case, the valve seat 50 tends to have a shape in which the direction in which the weld bead 90 protrudes is recessed with respect to the regular circle in the circumferential direction around the center point P. The effect (2) can also be realized by the injector 10 of the modification example.

In the injector 10, the weld bead 90 may have a trajectory of a rounded triangle. For example, as shown in FIG. 5, the weld bead 90 may be a weld bead 90B having a rounded equilateral triangle. When the weld bead 90 has a shape such as a weld bead 90B, the valve seat 50 tends to have a shape in which a direction corresponding to an apex of a rounded equilateral triangle is recessed toward the center point P. When the valve seat 50 has such a shape, the shape of the valve seat 50 in the cross section where the valve element 31 contacts the valve seat 50 is a shape indicated by a broken line in FIG. 5. A shape indicated by a broken line in FIG. 5 is an asymmetric shape. According to the injector 10 of the modified example, the effect (1) can be realized even when a shape close to a triangle is used.

The geometry of the weld bead 90 is not limited to a rounded equilateral triangle, such as a weld bead 90B. The shape of the weld bead 90 may be an equilateral triangle that is not rounded. The shape of the weld bead 90 may be another triangle. The weld bead 90 may be any triangle, for example, an isosceles triangle, a right triangle, an acute triangle, and an obtuse triangle. Further, the triangle may be a rounded triangle for any of the above triangles.

The shape of the weld bead 90 may be any three-fold rotationally symmetric figure in addition to a rounded triangle.

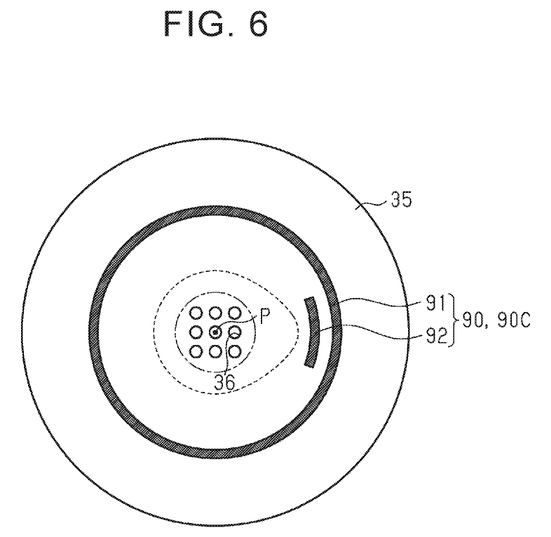

The injector 10 may include a first weld bead 91 and a second weld bead 92. The first weld bead 91 has a positive circular shape, and the weld bead 90 in the nozzle plate 35 is configured to surround a portion where the plurality of injection holes 36 of the nozzle plate 35 is located. The second weld bead 92 is provided inside the first weld bead 91 and in a part of the circumferential direction centered on the center point P. For example, the weld bead 90 may be a weld bead 90C as shown in FIG. 6.

In the injector 10, the first weld bead 91 and the second weld bead 92 form an asymmetric weld bead 90C. The rigidity of the right portion of the valve seat 50 where the first weld bead 91 and the second weld bead 92 are located is high. Therefore, as in the example shown in FIG. 3, the shape of the valve seat 50 tends to be a shape in which the right portion bulges radially outward. When the valve seat 50 has such a shape, the shape of the valve seat 50 in the cross section where the valve element 31 contacts the valve seat 50 is a shape indicated by a broken line in FIG. 6. The shape shown in FIG. 6 is an asymmetric shape.

Further, in the injector 10, since the first weld bead 91 is a positive circle, the strength of the welding is easily maintained high regardless of the direction of the force input to the weld bead 90. According to the injector 10, it is possible to realize the effect (1) while sufficiently maintaining the strength of the welded portion.

The weld bead 90 is not limited to a weld bead 90C shown in FIG. 6, which is composed of two trajectories of the first weld bead 91 and the second weld bead 92. The weld bead 90 may have three or more trajectories.

What is claimed is:

1. A fuel injection device that injects fuel by moving a needle accommodated in a fuel chamber in a housing along a central axis of the needle to move a valve element in a spherical shape provided at a tip of the needle away from a valve seat in an annular shape, wherein:
a plate having a plurality of injection holes is welded and fixed to an outer side of a distal end portion of the housing where the valve seat is provided with a locus surrounding a portion where the injection holes are located; and
when seen from a viewpoint at which the plate at the distal end portion is seen from front,
a weld bead is located on an outer side of an inner diameter of the valve seat and is asymmetric with respect to a point on a surface of the plate through which the central axis passes.

2. The fuel injection device according to claim 1, wherein the weld bead has a locus in a shape in which a part of a regular circle is recessed toward a center.

3. The fuel injection device according to claim 1, wherein the weld bead has a locus in a shape of a triangle with rounded corners.

4. The fuel injection device according to claim 1, wherein the weld bead on the plate is composed of a first weld bead in a shape of a regular circle surrounding a portion of the plate where the injection holes are located, and a second weld bead provided on an inner side of the first weld bead and for a part of the plate in a circumferential direction around a point through which the central axis passes.
